(19) United States
(12) Patent Application Publication
(10) Pub. No.: US 2026/0264961 A1
(43) Pub. Date: Sep. 10, 2026

(54) AIRTIGHT BREAD STORAGE DEVICE

(71) Applicant: Maria Chupungco, Niskayuna, NY (US)

(72) Inventor: Maria Chupungco, Niskayuna, NY (US)

(21) Appl. No.: 19/071,963

(22) Filed: Mar. 6, 2025

(51) Int. Cl. B65D 81/20; A23B 45/00; A47J 47/00; A47J 47/12; B65D 25/04; B65D 43/06; B65D 85/36

(52) U.S. Cl. CPC B65D 81/2038; A23B 45/00; A47J 47/005; A47J 47/12; B65D 25/04; B65D 43/065; B65D 85/36; B65D 2543/00092; B65D 2543/00361; B65D 2543/00953

(57) ABSTRACT

An airtight bread storage device for preserving the freshness of a loaf of bread includes a base and an annular ring extending upwardly from the base. A dome is positionable upon the base to define a containment space when the dome is positioned on the base to contain a loaf of bread. A locking element is attached to the dome which insertably receives the annular ring to secure the dome on the base. An air pump is coupled to the dome. The air pump generates negative pressure in the containment space when the air pump is actuated into a pumping condition. Furthermore, the air pump urges air outwardly from the containment space to inhibit the formation of mold on the loaf of bread.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to bread storage devices and more particularly pertains to a new bread storage device for storing a loaf of bread in a vacuum to inhibit the growth of mold on the loaf of bread. The device includes a base upon which the loaf of bread can be positioned and a dome that is positionable on the base to define a containment space in which the loaf of bread can be stored. The device includes an annular ring which is coupled to and extends upwardly from the base and a locking element that is coupled to the dome which releasably engages the annular ring to secure the dome to the base. The device includes an air pump which is integrated into the dome that purges air from the containment space to inhibit the growth of mold on the loaf of bread.

### (2) Description of Related Art including information disclosed under 37 CFR 1.97 and 1.98

The prior art relates to bread storage devices including: a vacuum sealed bread bin device that includes a housing and a door which forms an airtight seal when closed and an exhaust fan which is activated when the door is closed to store bread in vacuum; a variety of vacuum container devices that each at least includes a cylindrical housing and a plunger that evacuates air from the cylindrical housing; a vacuum food container device that includes a base which has a pair of lobes extending upwardly on either side of the base and a filter element that is positionable upon the base and a lid that has a Quonset shape with flattened ends to accommodate the lobes on the base and an electric air pump for evacuating air from the dome and base. In no instance does the prior art disclose a bread storage device that includes a base and an annular ring extending upwardly from the base and a dome that is positionable on the base and a locking element attached to the dome which engages the annular ring to secure the dome on the base and an air pump integrated into the dome to evacuate air from a containment space defined by the dome and the base for storing a loaf of bread in a vacuum.

### (h) BRIEF SUMMARY OF THE INVENTION

An embodiment of the disclosure meets the needs presented above by generally comprising a base and an annular ring extending upwardly from the base. A dome is positionable upon the base to define a containment space when the dome is positioned on the base to contain a loaf of bread. A locking element is attached to the dome which insertably receives the annular ring to secure the dome on the base. An air pump is coupled to the dome. The air pump generates negative pressure in the containment space when the air pump is actuated into a pumping condition. Furthermore, the air pump urges air outwardly from the containment space to inhibit the formation of mold on the loaf of bread.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an explode perspective view of an airtight bread storage device according to an embodiment of the disclosure.

FIG. 2 is a front view of an embodiment of the disclosure.

FIG. 3 is a cross sectional view taken along line 3-3 of FIG. 2 of an embodiment of the disclosure.

FIG. 4 is a perspective in-use view of an embodiment of the disclosure showing a vacuum being mated to an air valve.

### (j) DETAILED DESCRIPTION OF THE INVENTION

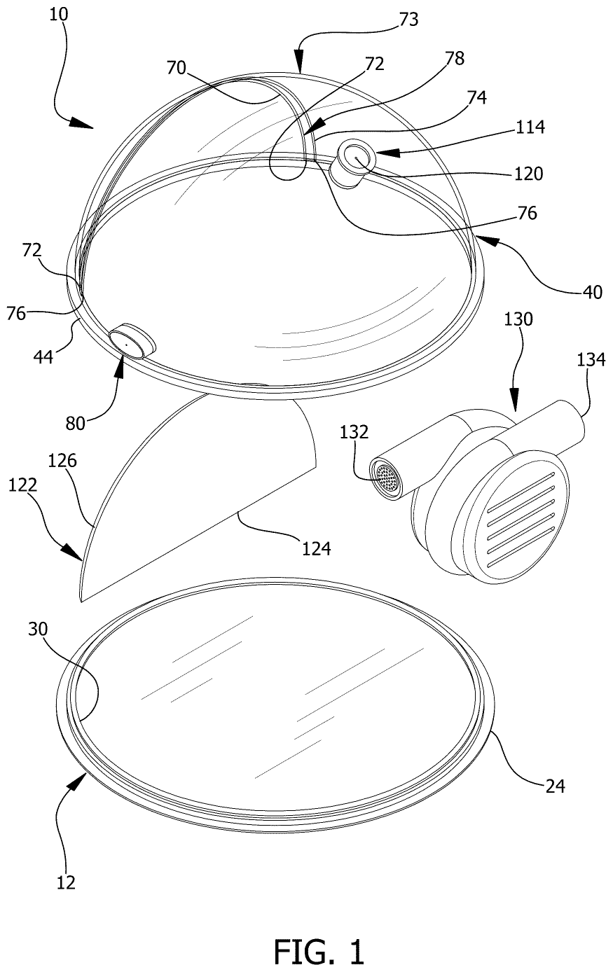

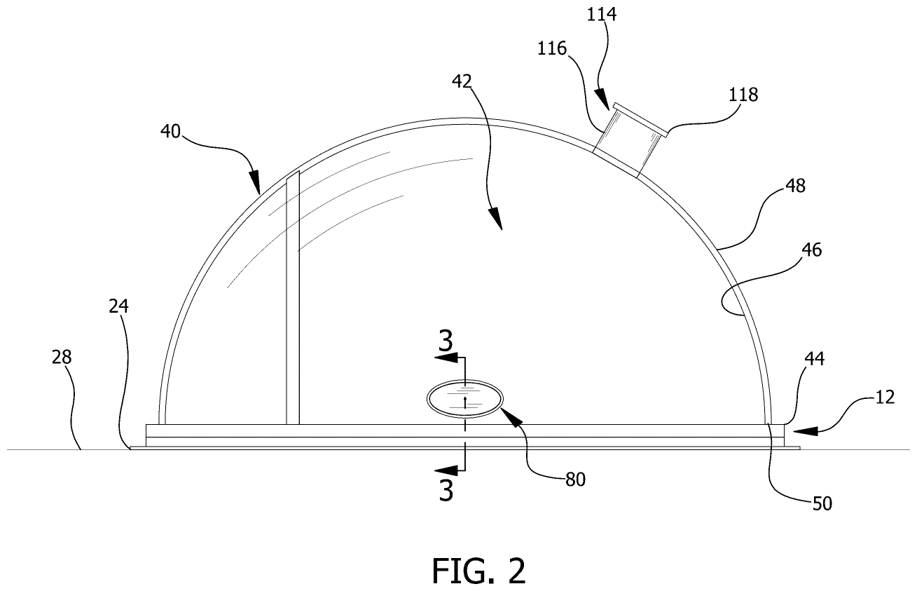

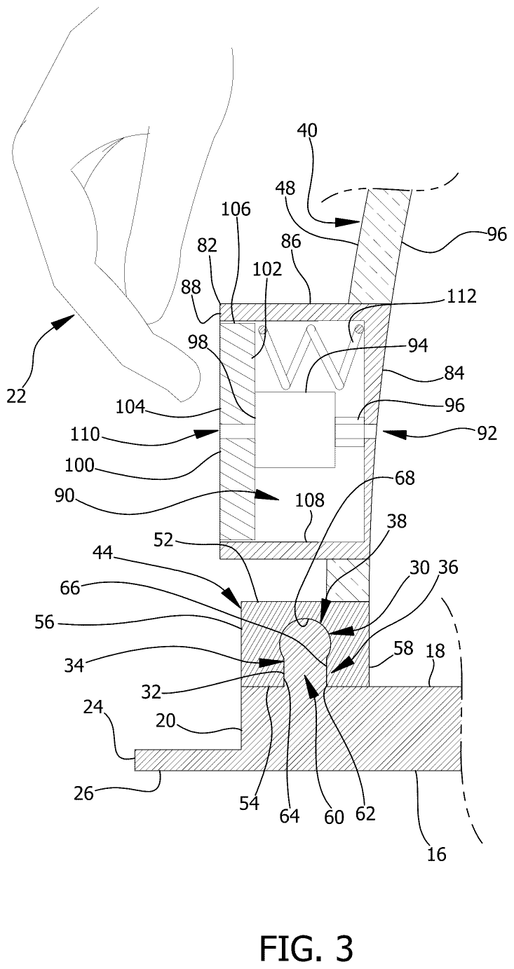

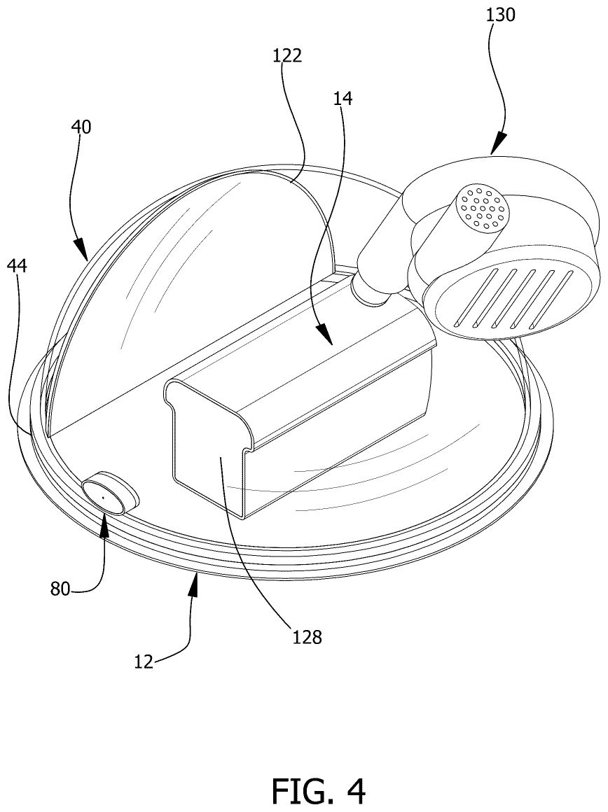

With reference now to the drawings, and in particular to FIGS. 1 through 4 thereof, a new bread storage device embodying the principles and concepts of an embodiment of the disclosure and generally designated by the reference numeral 10 will be described.

As best illustrated in FIGS. 1 through 4, the airtight bread storage device 10 generally comprises a base 12 which is comprised of a rigid material, including but not being limited to plastic or wood, such that a loaf of bread 14 can be positioned upon the base 12 such that the loaf of bread 14 can be sliced. The loaf of bread 14 may be sourdough bread or other type of bread that is highly prone to developing mold. The base 12 has a lower surface 16 and an upper surface 18 and a perimeter surface 20 extending between the lower surface 16 and the upper surface 18. The perimeter surface 20 is continuously arcuate about a center of the base 12 such that the base 12 has a circular shape. Furthermore, the base 12 accommodates the loaf of bread 14 without having protruding corners which could poke a user 22 when the user 22 is slicing the loaf of bread 14. The base 12 has a lip 24 extending outwardly from the perimeter surface 20 and the lip 24 extends around a full circumference of the perimeter surface 20. The lip 24 has a bottom surface 26 which is aligned with the lower surface 16 of the base 12 and the bottom surface 26 rests on a support surface 28 upon which the base 12 is positioned. The support surface 28 may be a table or other type of horizontal support surface.

An annular ring 30 is coupled to the base 12 and the annular ring 30 extends upwardly from the base 12. The annular ring 30 extends upwardly from the upper surface 18 of the base 12 and the annular ring 30 is spaced inwardly from the perimeter surface 20 of the base 12. The annular ring 30 is co-arcuate with the perimeter surface 20 such that the annular ring 30 forms a concentric circle with the perimeter surface 20. The annular ring 30 has an outer surface 32 and the outer surface 32 has a front planar portion 34 and a back planar portion 36 and a rounded portion 38. The front planar portion 34 lies on a plane that is oriented parallel to the perimeter surface 20 of the base 12 and the front planar portion 34 lies on a plane which is oriented perpendicular to the upper surface 18 of the base 12. The back planar portion 36 lies on a plane which is oriented parallel to the front planar portion 34 and the back planar portion 36 lying on a plane is oriented perpendicular to the upper surface 18 of the base 12. The rounded portion 38 curves outwardly and upwardly between each of the front planar portion 34 and the back planar portion 36 such that the rounded portion 38 defines a circular shape. Furthermore, the circular shape defined by the rounded portion 38 has a diameter which is greater than a distance between the front planar portion 34 and the back planar portion 36.

A dome 40 is provided and the dome 40 is positionable upon the base 12. The dome 40 and the base 12 define a containment space 42 when the dome 40 is positioned on the base 12 and the containment space 42 contains the loaf of bread 14. A locking element 44 is attached to the dome 40 and the locking element 44 insertably receives the annular ring 30 when the dome 40 is positioned on the base 12 to secure the dome 40 on the base 12 to retain the loaf of bread 14 upon the base 12. The dome 40 has an interior surface 46 and an exterior surface 48 and a bottom edge 50 extending between the interior surface 46 and the exterior surface 48. Furthermore, the dome 40 is comprised of a translucent material, including but not being limited to plastic or glass, such that dome 40 can pass light through the interior surface 46 and the exterior surface 48 such that the loaf of bread 14 is visible through the dome 40.

The locking element 44 has an uppermost surface 52 and a lowermost surface 54. The locking element 44 has a forward surface 56 extending between and being perpendicularly oriented with the uppermost surface 52 and the lowermost surface 54. Additionally, the locking element 44 has a rearward surface 58 extending between and being perpendicularly oriented with the uppermost surface 52 and the lowermost surface 54. The bottom edge 50 of the dome 40 is coupled to the uppermost surface 52 and the interior surface 46 of the dome 40 is aligned with the rearward surface 58. An intersection between the uppermost surface 52 and the rearward surface 58 is co-arcuate with an intersection between the bottom edge 50 of the dome 40 and the interior surface 46 of the dome 40 such that the locking element 44 extends around a full circumference of the bottom edge 50 of the dome 40. Furthermore, the exterior surface 48 of the dome 40 is spaced inwardly from the forward surface 56.

The locking element 44 has a recess 60 extending into the lowermost surface 54 toward the uppermost surface 52 and the recess 60 is centrally located between the forward surface 56 and the rearward surface 58. The recess 60 has a bounding surface 62 and the bounding surface 62 has a forward side 64 lying on a plane which is oriented parallel to the forward surface 56 of the locking element 44. Additionally, the bounding surface 62 has a rear side 66 lying on a plane which is oriented parallel to the rearward surface 58 of the locking element 44. The bounding surface 62 has an upper side 68 which is concavely arcuated between the forward side 64 and the rear side 66 such that the upper side 68 defines a circular shape.

The annular ring 30 extends upwardly into the recess 60 having the rounded portion 38 of the outer surface 32 of the annular ring 30 conforming to the upper side 68 of the bounding surface 62. The front planar portion 34 of the outer surface 32 of the annular ring 30 rests against the forward side 64 of the bounding surface 62 when the annular ring 30 extends into the recess 60. Additionally, the back planar portion 36 of the outer surface 32 of the annular ring 30 rests against the rear side 66 of the bounding surface 62 when the annular ring 30 extends into the recess 60. The annular ring 30 is comprised of a resiliently compressible material, including but not being limited to rubber or hardened silicone, such that the rounded portion 38 of the outer surface 32 of the annular ring 30 is compressed between the forwardmost side 104 and the rear side 66 of the bounding surface 62 of the recess 60 when the annular ring 30 extends into the recess 60.

The lowermost surface 54 of the locking element 44 rests upon the upper surface 18 of the base 12 when the annular ring 30 is seated in the recess 60. The forward surface 56 of the locking element 44 is aligned with the perimeter surface 20 of the base 12 when the annular ring 30 is seated in the recess 60. Additionally, the annular ring 30 forms a fluid impermeable seal with the recess 60 when the annular ring 30 is seated in the recess 60 to inhibit ambient air from moving into the dome 40 when the annular ring 30 is seated in the recess 60.

A first ridge 70 is coupled to and extends downwardly from the interior surface 46 of the dome 40 and the first ridge 70 has a pair of first terminal ends 72. The first ridge 70 is offset from an apex 73 of the dome 40 such that each first terminal end 72 of the pair of first terminal ends 72 intersects the bottom edge 50 of the dome 40 on opposite sides of the bottom edge 50. A second ridge 74 is coupled to and extends downwardly from the interior surface 46 of the dome 40 and the second ridge 74 has a pair of second terminal ends 76. The second ridge 74 is offset with the apex 73 of the dome 40 such that each second terminal end 76 of the pair of second terminal ends 76 intersects the bottom edge 50 of the dome 40 on opposite sides of the bottom edge 50. Additionally, the second ridge 74 is spaced from the first ridge 70 and the second ridge 74 is coextensive with the first ridge 70 to define a space 78 between the first ridge 70 and the second ridge 74.

An air pump 80 is coupled to the dome 40 and the air pump 80 is in fluid communication with the containment space 42 defined by the dome 40 and the base 12 when the dome 40 is positioned on the base 12. The air pump 80 generates negative pressure in the containment space 42 when the air pump 80 is actuated into a pumping condition. Furthermore, the air pump 80 urges air outwardly from the containment space 42 to inhibit the formation of mold on the loaf of bread 14. The air pump 80 comprises a housing 82 which has a rear wall 84 and an exterior wall 86 extending forwardly from the rear wall 84. The exterior wall 86 is continuously arcuate about a center of the rear wall 84 such that the housing 82 defines a rounded shape. The exterior wall 86 has a distal edge 88 with respect to the rear wall 84 and the distal edge 88 defines an opening 90 into the housing 82.

The housing 82 extends through the dome 40; the rear wall 84 is aligned with the interior surface 46 of the dome 40 and the housing 82 is spaced from the bottom edge 50 of the dome 40. The rear wall 84 has a first air hole 92 extending through the rear wall 84 to pass air through the first air hole 92. Additionally, the first air hole 92 is centrally located on the rear wall 84. The air pump 80 includes a pump 94 which has an inlet 96 and an outlet 98 and the pump 94 is positioned in the housing 82. The inlet 96 is in fluid communication with the first air hole 92. Additionally, the pump 94 generates suction between the inlet 96 and the outlet 98 when the pump 94 is actuated to urge air to travel into the inlet 96 and outwardly through the outlet 98. The pump 94 may comprise a mechanical air pump which permits air to flow from the inlet 96 to the outlet 98 but inhibits air to flow from the outlet 98 to the inlet 96.

The air pump 80 includes a disk 100 which has a rearmost side 102 and a forwardmost side 104 and a perimeter edge 106 extending between the forwardmost side 104 and the rearmost side 102. The disk 100 is positioned in the opening 90 defined by the distal edge 88 of the exterior wall 86 of the housing 82 and the disk 100 can be depressed by the user 22. The exterior wall 86 of the housing 82 has an inside surface 108 and the perimeter edge 106 of the disk 100 abuts the inside surface 108 of the exterior wall 86. The disk 100 has a second air hole 110 extending through the forwardmost side 104 and the rearmost side 102 and the second air hole 110 is centrally located on the disk 100. Additionally, the rearmost side 102 is coupled to the pump 94. The outlet 98 of the pump 94 is in fluid communication with the second air hole 110. The pump 94 is actuated when the disk 100 is depressed into the housing 82 to urge air inwardly through the first air hole 92 and outwardly through the second air hole 110 when the disk 100 is depressed by the user 22 to remove air from the containment space 42 defined by the dome 40 and the base 12. Additionally, the air pump 80 includes a biasing member 112 positioned between the rear wall 84 of the housing 82 and the rearmost side 102 of the disk 100; the biasing member 112 biases the disk 100 to travel away from the rear wall 84.

An air valve 114 is coupled to the dome 40 and the air valve 114 is in fluid communication with the containment space 42 defined by the dome 40 and the base 12. The air valve 114 has a first direction of flow such that the air valve 114 can pass air outwardly from the containment space 42 and inhibit air from passing into the containment space 42. The air valve 114 has a stem 116 extending through the dome 40 and the air valve 114 has a head 118 which is distally located with respect to the exterior surface 48 of the dome 40. The head 118 has an air port 120 extending through the head 118 and the air port 120 passes air through the head 118. The air valve 114 is positioned between the apex 73 of the dome 40 and the bottom edge 50 of the dome 40 and the air valve 114 is offset from the air pump 80.

A divider 122 is provided which has a lower edge 124 and an upper edge 126; the upper curves upwardly from the lower edge 124 such that the divider 122 has a semi-circular shape. The divider 122 is positionable on the base 12 having the lower edge 124 resting upon the upper surface 18 of the base 12. The upper edge 126 is positioned in the space 78 defined between the first ridge 70 and the second ridge 74 when the dome 40 is positioned on the base 12. Furthermore, a cut side 128 of the loaf of bread 14 can be positioned against the divider 122 when the loaf of bread 14 has been sliced.

A vacuum 130 is provided and the vacuum 130 is attachable to the air valve 114. The vacuum 130 generates negative pressure in the containment space 42 defined by the dome 40 and the base 12 when the vacuum 130 is turned on when the vacuum 130 is attached to the air valve 114. The vacuum 130 removes air from the containment space 42 to inhibit the formation of mold on the loaf of bread 14. The vacuum 130 has an input port 132 and an output port 134; the vacuum 130 urges air to travel between the input port 132 and the output port 134 when the vacuum 130 is turned on. Furthermore, the input port 132 is matable to the head 118 of the air valve 114 to urge air to travel outwardly through the air port 120 in the head 118 of the air valve 114 when the vacuum 130 is turned on. The vacuum 130 may comprise an electromechanical vacuum that includes an electric motor and a fan or other similar type of electronic air pump.

In use, the loaf of bread 14 is placed on the base 12 and the dome 40 is secured to the annular ring 30. The air pump 80 is manipulated to purge air from the containment space 42 defined by the dome 40 and the base 12. Furthermore, the lack of air in the containment space 42 inhibits the development of mold on the loaf of bread 14 to extend the shelf life of the loaf of bread 14. The divider 122 can be placed in the dome 40 when the loaf of bread 14 has been sliced such that the cut side 128 of the loaf of bread 14 can be positioned against the divider 122. Subsequently, the freshness of the cut side 128 of the loaf of bread 14 is preserved while the loaf of bread 14 is stored in the containment space 42. The vacuum 130 can be attached to the air valve 114 to purge the air from the containment space 42 rather than employing the air pump 80 to purge the air from the containment space 42, depending on the preference of the user 22. The disk 100 of the air pump 80 can be depressed and held in place to enable air to pass into the containment space 42 such that the dome 40 can be removed from the base 12 to access the loaf of bread 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An airtight bread storage device for storing a loaf of bread in a vacuum to inhibit the formation of mold on the loaf of bread, said device comprising:
a base being comprised of a rigid material wherein said base is configured to have the loaf of bread positioned upon said base such that the loaf of bread can be sliced;
an annular ring being coupled to said base, said annular ring extending upwardly from said base;
a dome being positionable upon said base, said dome and said base defining a containment space when said dome is positioned on said base wherein said containment space is configured to contain the loaf of bread;
a locking element being attached to said dome, said locking element insertably receiving said annular ring when said dome is positioned on said base, said annular ring securing said dome on said base wherein said dome is configured to retain the loaf of bread upon said base; and
an air pump being coupled to said dome, said air pump being in fluid communication with said containment space defined by said dome and said base when said dome is positioned on said base, said air pump generating negative pressure in said containment space when said air pump is actuated into a pumping condition wherein said air pump is configured to urge air outwardly from said containment space to inhibit the formation of mold on the loaf of bread.

2. The airtight bread storage device according to claim 1, wherein:
said base has a lower surface and an upper surface and a perimeter surface extending between said lower surface and said upper surface;
said perimeter surface is continuously arcuate about a center of said base such that said base has a circular shape wherein said base is configured to accommodate the loaf of bread without having protruding corners which could poke a user when the user is slicing the loaf of bread;
said base has a lip extending outwardly from said perimeter surface;
said lip extends around a full circumference of said perimeter surface; and
said lip has a bottom surface being aligned with said lower surface of said base wherein said bottom surface is configured to rest on a support surface upon which said base is positioned.

3. The airtight bread storage device according to claim 2, wherein:
said annular ring extends upwardly from said upper surface of said base;
said annular ring is spaced inwardly from said perimeter surface of said base;
said annular ring is co-arcuate with said perimeter surface such that said annular ring forms a concentric circle with said perimeter surface;
said annular ring has an outer surface;
said outer surface has a front planar portion and a back planar portion and a rounded portion;
said front planar portion lies on a plane being oriented parallel to said perimeter surface of said base;
said front planar portion lies on a plane being oriented perpendicular to said upper surface of said base;
said back planar portion lies on a plane being oriented parallel to said front planar portion;
said back planar portion lies on a plane being oriented perpendicular to said upper surface of said base;
said rounded portion curves outwardly and upwardly between each of said front planar portion and said back planar portion such that said rounded portion defines a circular shape; and
said circular shape defined by said rounded portion has a diameter being greater than a distance between said front planar portion and said back planar portion.

4. The airtight bread storage device according to claim 1, wherein:
said dome has an interior surface and an exterior surface and a bottom edge extending between said interior surface and said exterior surface;
said locking element has an uppermost surface and a lowermost surface;
said locking element has a forward surface extending between and being perpendicularly oriented with said uppermost surface and said lowermost surface;
said locking element has a rearward surface extending between and being perpendicularly oriented with said uppermost surface and said lowermost surface;
said bottom edge of said dome is coupled to said uppermost surface;
said interior surface of said dome is aligned with said rearward surface;
an intersection between said uppermost surface and said rearward surface is co-arcuate with an intersection between said bottom edge of said dome and said interior surface of said dome such that said locking element extends around a full circumference of said bottom edge of said dome; and
said exterior surface of said dome is spaced inwardly from said forward surface.

5. The airtight bread storage device according to claim 4, wherein:
said locking element has a recess extending into said lowermost surface toward said uppermost surface;
said recess is centrally located between said forward surface and said rearward surface;
said recess has a bounding surface;
said bounding surface has a front side lying on a plane being oriented parallel to said forward surface of said locking element;
said bounding surface has a back side lying on a plane being oriented parallel to said rearward surface of said locking element; and
said bounding surface has an upper side being concavely arcuated between said front side and said back side such that said upper side defines a circular shape.

6. The airtight bread storage device according to claim 5, wherein:
said annular ring has an outer surface;
said outer surface has a front planar portion;
said outer surface has a back planar portion;
said outer surface has a rounded portion;
said annular ring extends upwardly into said recess having said rounded portion of said outer surface of said annular ring conforming to said upper side of said bounding surface;
said front planar portion of said outer surface of said annular ring resting against said front side of said bounding surface when said annular ring extends into said recess; and
said back planar portion of said outer surface of said annular ring rests against said back side of said bounding surface when said annular ring extends into said recess.

7. The airtight bread storage device according to claim 6, wherein said annular ring is comprised of a resiliently compressible material such that said rounded portion of said outer surface of said annular ring is compressed between said front side and said back side of said bounding surface of said recess when said annular ring extends into said recess.

8. The airtight bread storage device according to claim 5, wherein:
said base has an upper surface and a perimeter surface;
said lowermost surface of said locking element rests upon said upper surface of said base when said annular ring is seated in said recess;
said forward surface of said locking element is aligned with said perimeter surface of said base when said annular ring is seated in said recess; and
said annular ring forms a fluid impermeable seal with said recess when said annular ring is seated in said recess wherein said annular ring is configured to inhibit ambient air from moving into said dome when said annular ring is seated in said recess.

9. The airtight bread storage device according to claim 4, further comprising:
a first ridge being coupled to and extending downwardly from said interior surface of said dome;
said first ridge having a pair of first terminal ends;
said first ridge being offset from an apex of said dome such that each first terminal end of said pair of first terminal ends intersects said bottom edge of said dome on opposite sides of said bottom edge;
a second ridge being coupled to and extending downwardly from said interior surface of said dome;
said second ridge having a pair of second terminal ends;
said second ridge being offset with said apex of said dome such that each second terminal end of said pair of second terminal ends intersects said bottom edge of said dome on opposite sides of said bottom edge;
said second ridge being spaced from said first ridge; and
said second ridge being coextensive with said first ridge to define a space between said first ridge and said second ridge.

10. The airtight bread storage device according to claim 4, wherein:
said air pump includes a housing having a rear wall and an exterior wall extending forwardly from said rear wall;
said exterior wall is continuously arcuate about a center of said rear wall such that said housing defines a rounded shape;
said exterior wall has a distal edge with respect to said rear wall;
said distal edge defines an opening into said housing;
said housing extends through said dome;
said rear wall is aligned with said interior surface of said dome;
said housing is spaced from said bottom edge of said dome;
said rear wall has a first air hole extending through said rear wall wherein said first air hole is configured to pass air through said first air hole; and
said first air hole is centrally located on said rear wall.

11. The airtight bread storage device according to claim 10, wherein:
said air pump includes a pump which has an inlet and an outlet;
said pump is positioned in said housing;
said inlet is in fluid communication with said first air hole;
said pump generates suction between said inlet and said outlet when said pump is actuated wherein said pump is configured to urge air to travel into said inlet and outwardly through said outlet.

12. The airtight bread storage device according to claim 11, wherein:
said air pump includes a disk has a rearmost side and a forwardmost side and a perimeter edge extending between said forwardmost side and said rearmost side;
said disk is positioned in said opening defined by said distal edge of said exterior wall of said housing wherein said disk is configured to be depressed by the user;
said exterior wall of said housing has an inside surface;
said perimeter edge of said disk abuts said inside surface of said exterior wall;
said disk has a second air hole extending through said forwardmost side and said rearmost side;
said second air hole is centrally located on said disk; and
said rearmost side is coupled to said pump.

13. The airtight bread storage device according to claim 12, wherein
said outlet of said pump is in fluid communication with said second air hole;
said pump is actuated when said disk is depressed into said housing wherein said pump is configured to urge air inwardly through said first air hole and outwardly through said second air hole when said disk is depressed by the user to remove air from said containment space defined by said dome and said base;
said air pump includes a biasing member being positioned between said rear wall of said housing and said rear side of said disk; and
said biasing member biases said disk to travel away from said rear wall.

14. The airtight bread storage device according to claim 1, further comprising:
said dome having an exterior surface and a bottom edge;
an air valve being coupled to said dome;
said air valve being in fluid communication with said containment space defined by said dome and said base;
said air valve having a first direction of flow wherein said air valve is configured to pass air outwardly from said containment space and inhibit air from passing into said containment space;
said air valve having a stem extending through said dome;
said air valve having a head being distally located with respect to said exterior surface of said dome;
said head having an air port extending through said head wherein said air port is configured to pass air through said head;
said air valve being positioned between an apex of said dome and said bottom edge of said dome; and
said air valve being offset from said air pump.

15. The airtight bread storage device according to claim 4, further comprising:
said base having an upper surface;
a divider having a lower edge and an upper edge;
said upper curving upwardly from said lower edge such that said divider has a semi-circular shape;
said divider being positionable on said base having said lower edge resting upon said upper surface of said base; and
said upper edge being positioned in said space defined between said first ridge and said second ridge when said dome is positioned on said base wherein said divider is configured to be positioned against a cut side of the loaf of bread when the loaf of bread has been sliced.

16. The airtight bread storage device according to claim 14, further comprising:
a vacuum being attachable to said air valve;
said vacuum generating negative pressure in said containment space defined by said dome and said base when said vacuum is turned on when said vacuum is attached to said air valve wherein said vacuum is configured to remove air from said containment space to inhibit the formation of mold on the bread;
said vacuum having an input port and an output port wherein said vacuum is configured to urge air to travel between said input port and said output port when said vacuum is turned on; and
said input port being matable to said head of said air valve wherein said input port is configured to urge air to travel outwardly through said air port in said head of said air valve when said vacuum is turned on.

17. An airtight bread storage device for storing a loaf of bread in a vacuum to inhibit the formation of mold on the loaf of bread, said device comprising:
a base being comprised of a rigid material wherein said base is configured to have the loaf of bread positioned upon said base such that the loaf of bread can be sliced, said base having a lower surface and an upper surface and a perimeter surface extending between said lower surface and said upper surface, said perimeter surface being continuously arcuate about a center of said base such that said base has a circular shape wherein said base is configured to accommodate the loaf of bread without having protruding corners which could poke a user when the user is slicing the loaf of bread, said base having a lip extending outwardly from said perimeter surface, said lip extending around a full circumference of said perimeter surface, said lip having a bottom surface being aligned with said lower surface of said base wherein said bottom surface is configured to rest on a support surface upon which said base is positioned;
an annular ring being coupled to said base, said annular ring extending upwardly from said base, said annular ring extending upwardly from said upper surface of said base, said annular ring being spaced inwardly from said perimeter surface of said base, said annular ring being co-arcuate with said perimeter surface such that said annular ring forms a concentric circle with said perimeter surface, said annular ring having an outer surface, said outer surface having a front planar portion and a back planar portion and a rounded portion, said front planar portion lying on a plane being oriented parallel to said perimeter surface of said base, said front planar portion lying on a plane being oriented perpendicular to said upper surface of said base, said back planar portion lying on a plane being oriented parallel to said front planar portion, said back planar portion lying on a plane being oriented perpendicular to said upper surface of said base, said rounded portion curving outwardly and upwardly between each of said front planar portion and said back planar portion such that said rounded portion defines a circular shape, said circular shape defined by said rounded portion having a diameter being greater than a distance between said front planar portion and said back planar portion;
a dome being positionable upon said base, said dome and said base defining a containment space when said dome is positioned on said base wherein said containment space is configured to contain the loaf of bread, said dome having an interior surface and an exterior surface and a bottom edge extending between said interior surface and said exterior surface, said dome being comprised of a translucent material wherein said dome is configured to pass light through said interior surface and said exterior surface such that the loaf of bread is visible through said dome;
a first ridge being coupled to and extending downwardly from said interior surface of said dome, said first ridge having a pair of first terminal ends, said first ridge being offset from an apex of said dome such that each first terminal end of said pair of first terminal ends intersects said bottom edge of said dome on opposite sides of said bottom edge;
a second ridge being coupled to and extending downwardly from said interior surface of said dome, said second ridge having a pair of second terminal ends, said second ridge being offset with said apex of said dome such that each second terminal end of said pair of second terminal ends intersects said bottom edge of said dome on opposite sides of said bottom edge, said second ridge being spaced from said first ridge, said second ridge being coextensive with said first ridge to define a space between said first ridge and said second ridge;
a locking element being attached to said dome, said locking element insertably receiving said annular ring when said dome is positioned on said base, said annular ring securing said dome on said base wherein said dome is configured to retain the loaf of bread upon said base, said locking element having an uppermost surface and a lowermost surface, said locking element having a forward surface extending between and being perpendicularly oriented with said uppermost surface and said lowermost surface, said locking element having a rearward surface extending between and being perpendicularly oriented with said uppermost surface and said lowermost surface, said bottom edge of said dome being coupled to said uppermost surface, said interior surface of said dome being aligned with said rearward surface, an intersection between said uppermost surface and said rearward surface being co-arcuate with an intersection between said bottom edge of said dome and said interior surface of said dome such that said locking element extends around a full circumference of said bottom edge of said dome, said exterior surface of said dome being spaced inwardly from said forward surface, said locking element having a recess extending into said lowermost surface toward said uppermost surface, said recess being centrally located between said forward surface and said rearward surface, said recess having a bounding surface, said bounding surface having a front side lying on a plane being oriented parallel to said forward surface of said locking element, said bounding surface having a back side lying on a plane being oriented parallel to said rearward surface of said locking element, said bounding surface having an upper side being concavely arcuated between said front side and said back side such that said upper side defines a circular shape, said annular ring extending upwardly into said recess having said rounded portion of said outer surface of said annular ring conforming to said upper side of said bounding surface, said front planar portion of said outer surface of said annular ring resting against said front side of said bounding surface when said annular ring extends into said recess, said back planar portion of said outer surface of said annular ring resting against said back side of said bounding surface when said annular ring extends into said recess, said annular ring being comprised of a resiliently compressible material such that said rounded portion of said outer surface of said annular ring is compressed between said front side and said back side of said bounding surface of said recess when said annular ring extends into said recess, said lowermost surface of said locking element resting upon said upper surface of said base when said annular ring is seated in said recess, said forward surface of said locking element being aligned with said perimeter surface of said base when said annular ring is seated in said recess, said annular ring forming a fluid impermeable seal with said recess when said annular ring is seated in said recess wherein said annular ring is configured to inhibit ambient air from moving into said dome when said annular ring is seated in said recess;
an air pump being coupled to said dome, said air pump being in fluid communication with said containment space defined by said dome and said base when said dome is positioned on said base, said air pump generating negative pressure in said containment space when said air pump is actuated into a pumping condition wherein said air pump is configured to urge air outwardly from said containment space to inhibit the formation of mold on the loaf of bread, said air pump comprising:
a housing having a rear wall and an exterior wall extending forwardly from said rear wall, said exterior wall being continuously arcuate about a center of said rear wall such that said housing defines a rounded shape, said exterior wall having a distal edge with respect to said rear wall, said distal edge defining an opening into said housing, said housing extending through said dome, said rear wall being aligned with said interior surface of said dome, said housing being spaced from said bottom edge of said dome, said rear wall having a first air hole extending through said rear wall wherein said first air hole is configured to pass air through said first air hole, said first air hole being centrally located on said rear wall;
a pump having an inlet and an outlet, said pump being positioned in said housing, said inlet being in fluid communication with said first air hole, said pump generating suction between said inlet and said outlet when said pump is actuated wherein said pump is configured to urge air to travel into said inlet and outwardly through said outlet;
a disk having a rearmost side and a forwardmost side and a perimeter edge extending between said forwardmost side and said rearmost side, said disk being positioned in said opening defined by said distal edge of said exterior wall of said housing wherein said disk is configured to be depressed by the user, said exterior wall of said housing having an inside surface, said perimeter edge of said disk abutting said inside surface of said exterior wall, said disk having a second air hole extending through said forwardmost side and said rearmost side, said second air hole being centrally located on said disk, said rearmost side being coupled to said pump, said outlet of said pump being in fluid communication with said second air hole, said pump being actuated when said disk is depressed into said housing wherein said pump is configured to urge air inwardly through said first air hole and outwardly through said second air hole when said disk is depressed by the user to remove air from said containment space defined by said dome and said base; and
a biasing member being positioned between said rear wall of said housing and said rearmost side of said disk, said biasing member biasing said disk to travel away from said rear wall;
an air valve being coupled to said dome, said air valve being in fluid communication with said containment space defined by said dome and said base, said air valve having a first direction of flow wherein said air valve is configured to pass air outwardly from said containment space and inhibit air from passing into said containment space, said air valve having a stem extending through said dome, said air valve having a head being distally located with respect to said exterior surface of said dome, said head having an air port extending through said head wherein said air port is configured to pass air through said head, said air valve being positioned between said apex of said dome and said bottom edge of said dome, said air valve being offset from said air pump;
a divider having a lower edge and an upper edge, said upper curving upwardly from said lower edge such that said divider has a semi-circular shape, said divider being positionable on said base having said lower edge resting upon said upper surface of said base, said upper edge being positioned in said space defined between said first ridge and said second ridge when said dome is positioned on said base wherein said divider is configured to be positioned against a cut side of the loaf of bread when the loaf of bread has been sliced; and
a vacuum being attachable to said air valve, said vacuum generating negative pressure in said containment space defined by said dome and said base when said vacuum is turned on when said vacuum is attached to said air valve wherein said vacuum is configured to remove air from said containment space to inhibit the formation of mold on the bread, said vacuum having an input port and an output port wherein said vacuum is configured to urge air to travel between said input port and said output port when said vacuum is turned on, said input port being matable to said head of said air valve wherein said input port is configured to urge air to travel outwardly through said air port in said head of said air valve when said vacuum is turned on.
